(19) United States
(12) Patent Application Publication
(10) Pub. No.: US 2005/0244601 A1
(43) Pub. Date: Nov. 3, 2005

(54) Biaxial stretch tubular film for the packaging and covering of meat with or without bones or paste-like foodstuffs and use thereof

(75) Inventors: Hartmut Grund, Otterstadt (DE); Frank Raue, Karlsruhe (DE); Helmut Schauer, Heddesheim (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: Naturin Gmbh & Co., Weinheim (DE)

(21) Appl. No.: 10/518,542

(22) PCT Filed: Jul. 5, 2002
(86) PCT No.: PCT/EP02/07498

§ 371 Date: May 24, 2005

(51) Int. Cl. B32B 1/08

(52) U.S. Cl. 428/34.9; 428/36.91

(57) ABSTRACT

The invention relates to a biaxial stretch tubular film with at least five layers and which may be shrunk and sealed, for the packaging and covering of meat, meat with bones or paste-like foodstuffs and use thereof. Said tubular film has the first four layers thereof, counting from the inside out, made from at least one polyolefin and/or modified polyolefin. A layer or several layers follow on said layers which are made from polyvinylidene chloride copolymer and/or polyamide and/or ethylene vinyl alcohol copolymer and/or polyolefin and/or modified polyolefin.

The invention relates to a biaxially oriented, at least five-layered, shrinkable and sealable tubular film and to its use for the packaging and wrapping of meat, which may include bones, and for pasty foodstuffs.

Packaging envelopes for meat with bones (bags usually consisting of a tubular film sealed by the manufacturer at one end with a transversal seal seam) not only must be impermeable to oxygen and water vapor, so as to prevent spoiling or drying of the packaged items, but are also required to withstand high mechanical stress during filling and further steps of packaging following sealing of the bag, such as shrinking the envelope onto the packaged items by heating, and during storage and shipping. In particular, there is a risk of sharp bones piercing through the packaging envelope. Therefore, in addition to any other properties important to packaging envelopes for meat, such meat packagings must have good sealability, with absolute tightness of the seal seam even under load, as well as high puncture resistance.

A bag arrangement for packaging meat with bones, consisting of shrinkable and heat-sealable film wrappings, has already been described in U.S. Pat. No. 6,004,599. To increase the puncture resistance, two engaging bags are used, each one consisting of a three-layered film. During use, the meat with bones, which is to be packaged, is successively packed in two bags, so that the double wall thickness of one single bag is available to increase the puncture resistance to protruding bones. The two bags are sealed at their bottoms, the seal seam of the inner bag being provided with interruptions so as to allow removal of air from the inner bag during final evacuation before sealing the outer bag which is longer than the inner bag. However, this solution is cumbersome and costly.

CA 2,230,820 describes a puncture-resistant film bag produced from flat films sealed one on top of the other, which bag is used for packaging bony meat and includes areas having a seven-layered film structure. The seven-layered film areas have a polyethylene as outer heat-sealable layer, produced using e.g. a metallocene catalyst, followed by an intermediate layer of polyamide, e.g. PA6/66, coated by means of a polyolefin-based adhesion-promoting layer, said intermediate layer being followed by a core layer serving as oxygen barrier and consisting of e.g. EVOH (ethylene-vinyl alcohol), followed by another intermediate layer made of polyamide as above, and polyethylene as inner, heat-sealable layer, produced using e.g. a metallocene catalyst, which is joined with the polyamide layer via a polyolefin-based adhesion-promoting layer. In this structure, the inner and outer layers are used for heat-sealing and as a moisture protection for the core layer, conferring stability to the overall structure. Likewise, the intermediate layers of polyamide enclosing the core layer confer stability to the film, namely, puncture resistance, as well as heat resistance. The film bag, which can be used for packaging meat with bones, consists of two film sections made of a seven-layered film and placed one on top of the other, which sections may merge at one of their contact edges, being joined with each other at two other contact edges by heat sealing. The non-joined edges of said seven-layered film sections lying one on top of the other form an opening extended by attached thinner, three-layered film sections. The three-layered film sections are joined by heat sealing to form a tube open at both ends, or joined with the opening of the seal-joined seven-layered film sections to form a continuous film bag.

After filling the bag with the items to be packaged, the bag is sealed by sealing the thin, i.e. three-layered film sections one on top of the other, the seven-layered film sections being intended to form the puncture-resistant region of the bag. The above state of the art not only suffers from the disadvantage of a complex process to produce the sealable bag by sealing several film sections of different structure and different thickness one on top of the other, but also fails to achieve the combination of a puncture-resistant film tube with high seal seam strength. That is, sealing of the above film bag is effected in the region of the three-layered and thin-walled film sections formed adjacent to the puncture-resistant seven-layered section of the film bag intended to receive the meat with bones. Rather, such a film bag results in separation of the properties of puncture resistance—provided by the seven-layered film—and sealing of the bag, namely, at the attached three-layered thinner film sections.

EP 0 987 103 A1 discloses flat films of a symmetrical structure made up of five layers in total in such a way that a core layer is enclosed on both sides by an adjacent layer which in turn has identical polymers coated thereon as outer layers. Polyamide and polyamide blends, e.g. polyamides based on hexamethylenediamine, m-xylylenediamine, sebacic acid and adipic acid or blends with ethylene-vinyl alcohol copolymer, are used as core layer. The layers enclosing the core layer consist of anhydride-grafted polyolefin, namely, butene-based linear low-density polyethylene.

DE 43 39 337 A1 discloses a five-layered, biaxially oriented tubular film for packaging and wrapping pasty foodstuffs, e.g. sausages. In this tubular film, a core layer of polyolefin is surrounded on both sides by intermediate layers made of the same material, which layers in turn are coated on both sides with an inner or outer layer made of the same polyamide material. The inner and outer layers consist of at least one aliphatic polyamide and/or at least one aliphatic copolyamide and at least one partially aromatic polyamide and/or at least one partially aromatic copolyamide, the amount of partially aromatic polyamide and/or copolyamide being from 5 to 60 wt.-%, relative to the total weight of the polymer blend of partially aromatic and aliphatic polyamides and copolyamides. Such a tubular film, produced by coextrusion, is provided with controlled shrinkability by biaxial stretching and heat-setting. This structure is particularly suitable for wrapping sausage, because the inner polyamide layer has good sausage meat adherence, the core layer of polyolefin forms a water vapor barrier, and the outer polyamide layer both mediates structural stability and represents an oxygen barrier separated from the packaged item by the core layer in a moisture-proof fashion. On the one hand, the polyamide inner layer is particularly advantageous as a result of its good sausage meat adherence and, on the other hand, because the inner layer provides a joint of high seal seam strength upon thermal fusion. To seal such a film, the sealing bar must be adjusted to a temperature of at least 140° C. as so-called sealing temperature.

More specifically, the tubular films described so far have disadvantageous technological properties in that their strength is not sufficient to avoid piercing thereof by bones contained therein together with meat. When packaging meat with bones there is a risk of protruding bones piercing through the packaging film during or after shrinking the packaging film onto the packaged item, e.g. by applying a vacuum to the tubular film. With bags produced using such tubular films, the strength of the seal seam is a crucial issue. For example, when a piece of ham or meat drops out of a spout and into a bag made of a plastic film and sealed at its bottom by a heat-seal seam, considerable strain—depending on the weight—arises due to the product to be packaged dropping into the bag, possibly giving rise to tearing of the heat-seal seam and complete opening of the bag at the bottom thereof. Also, the heat-seal seam is exposed to extreme stress during subsequent vacuum treatment and shrinking of the bags. Likewise, shipment and storage of the filled bags involve high demands on the puncture resistance of the film and on the seal seam strength. When using such tubular films, a general issue is to make sure that the tubular films would be sealable by heat sealing in a simple manner, so that high seal seam strength is achieved even in those cases where sealing must be effected through residues of the items to be packaged, such as meat fibers, fat, water, blood, or skin residues.

Increased puncture resistance of film wrappings used to package meat with bones has been disclosed in the following papers:

From AU 199938013 A1, a bag for packaging meat with bones is known, which is said to have improved puncture resistance. This bag consists of a three-layered film, the surface of which is partially covered with an additionally applied piece of film. The film material of the actual bag has a three-layered structure consisting of an inner heat-sealable layer, an outer wear layer, as well as a core layer serving as barrier layer. The barrier layer prevents permeation of oxygen and is made of e.g. EVOH or vinylidene chloride copolymers (VDC) and VDC-vinyl chloride or VDC-methyl acrylate or a blend thereof. The sealable inner layer consists of a blend of a copolymer of ethylene with C₃-C₁₀ α-olefins as a first component with a melting point of from 55 to 90° C., e.g. polyethylene produced using metallocene catalysts. In addition, an ethylene-α-olefin polymer with a melting point of from 90 to 100° C., e.g. another polyethylene produced using a metallocene catalyst, as well as another thermoplastic copolymer of ethylene and at least one α-olefin with a melting point of from 115 to 130° C. are included as further components of the inner layer. Additional polymers, especially ethylene-vinyl acetate copolymer (EVA), are mentioned as further possible component of the inner layer. The wear layer also consists of a mixture of non-functionalized polyolefins, such as low-density polyethylene in mixture with EVA. The film section attached on the outside in a particular area, which increases the puncture resistance in the particular area, essentially consists of a low-melting polyolefin, e.g. polyethylene, a low-density polyethylene produced using a metallocene catalyst, and another low-density polyethylene.

The tubular film in accordance with AU 199938013 A1 suffers from the drawback that a piece of meat with bones, which is to be packaged, must be oriented such that the bones are directed towards the film section attached in a particular area, so as to prevent piercing of the non-reinforced area of the tubular film. Furthermore, the sealability is impaired in those areas where the additionally applied film section increases the thickness of the tubular film, because the heat transfer in this region has been changed as a result of the additionally applied piece of film.

The application PCT/EP01/01066, not previously published, describes a multilayered, preferably five-layered, biaxially shrinkably stretched, sealable tubular film for packaging and wrapping meat, meat with bones and pasty foodstuffs, which film has increased seal seam strength even at low sealing temperatures, as well as high puncture resistance. This tubular film has an inner layer comprised of at least one copolyamide and at least one amorphous polyamide and/or at least one homopolyamide and/or at least one modified polyolefin, a middle polyolefin layer, as well as an outer layer comprised of at least one homopolyamide and/or at least one copolyamide and/or at least one copolymer of ethylene-vinyl alcohol and/or a modified polyolefin. Two intermediate layers are situated between the inner layer and middle layer and between the middle layer and outer layer.

However, even the above sealable tubular film is found to require improvement. Namely, it has been found that heat-sealing, especially at low temperatures, fails to work, i.e. fails to achieve a tight and mechanically tough seal seam in those cases where the inner layer is soiled with adherent residues of blood, meat, skin and/or bone at positions which must be heated for sealing.

The object of the present invention is therefore to provide a biaxially oriented, shrinkable and sealable tubular film for packaging meat with bones which, in addition to low water vapor and oxygen permeabilities, has high puncture resistance at lowest possible wall thickness and also, good sealability. Good sealability implies the outstanding feature of achieving high seal seam strength at lowest possible sealing temperatures, even when sealing is effected through soiled areas. Furthermore, a tubular film is to be provided which exhibits the outstanding features of good imprintability of the outer surface, good extrudability and easy opening of the folded film tube.

Although sealability of polyolefins has been known for quite some time, meat packages including bones obviously have been considered to necessarily require designing the actual packaging envelopes by special means, such as reinforcing films or double wrappings, in order to guarantee or ensure the required puncture resistance to protruding bones. To date, no one had ever envisaged the use of “normal” packaging envelopes for meat packages including bones, neither in case of multilayered ones, not to mention the problem of seal seam tightness in case of soiling. With the tubular film according to the invention, it is possible to combine a comparably thin film with high seal seam tightness, with no additional, complex reinforcing elements.

According to the invention, said object is accomplished by means of an at least five-layered, biaxially oriented, shrinkable and sealable tubular film wherein the first four layers, counted from the inside to the outside, consist of polyolefin and/or modified polyolefin. Said polyolefins are homopolymers of ethylene or propylene and/or copolymers of linear α-olefins having 2 to 8 C atoms. Modified polyolefins are copolymers of ethylene or propylene and optionally further linear α-olefins having 3 to 8 C atoms with α,β-unsaturated carboxylic acids, preferably acrylic acid, methacrylic acid and/or metal salts thereof and/or alkyl esters thereof, or appropriate graft copolymers of the above-mentioned monomers on polyolefins or partially saponified ethylene-vinyl acetate copolymers which are optionally graft-polymerized with an α,β-unsaturated carboxylic acid and have a low saponification level, or mixtures thereof. Furthermore, the modified polyolefins can be modified homo- or copolymers of ethylene and/or propylene and optionally other linear α-olefins having 3 to 8 C atoms, which have monomers from the group of α,β-unsaturated dicarboxylic acids, preferably maleic acid, fumaric acid, itaconic acid, or anhydrides, esters, amides or imides thereof grafted thereon. Said polyolefins and/or modified polyolefins are remarkable for their melting temperatures of about 70 to 130° C., melt index of about 0.2 to 15 g/10 min (ISO 1133) and density of about 0.86 to 0.98 g/cm³ (ISO 1183). The first layer preferably consists of LDPE with a high proportion of linear structures. For example, these are low-density polyethylenes produced using a metallocene catalyst. These LDPEs are also referred to as metallocene LLDPEs or mLLDPEs. The third layer preferably consists of polyethylene or polypropylene and/or copolymers of linear α-olefins having 2 to 8 C atoms, preferably of linear low-density polyethylene, high-density polyethylene, polypropylene homopolymer, polypropylene block copolymer and polypropylene random copolymer. The first layer has a wall thickness between 5 and 20 μm, the third layer between 5 and 30 μm. The second and fourth layers each have a wall thickness between 3 and 25 μm.

The first four layers of polyolefin and/or modified polyolefin are followed by at least one or more additional layers providing the film with stability and barrier properties against gases and also, protect it against mechanical damage from the outside.

Preferably, polyvinylidene chloride copolymers, polyamides or blends of polyamides, ethylene-vinyl alcohol copolymers or blends of polyamides and ethylene-vinyl alcohol are possible as polymers for the gas barrier.

Polyvinylidene chloride copolymers consist of the monomers vinylidene chloride and vinyl chloride and/or methyl acrylate, the proportion of vinylidene chloride being at least 50%.

The polyamides are well-known homo- and copolyamides and can be produced from the corresponding monomers, such as caprolactam, laurinlactam, ω-aminoundecanoic acid, adipic acid, azelaic acid, sebacic acid, decanedicarboxylic acid, dodecanedicarboxylic acid, terephthalic acid, isophthalic acid, tetramethylenediamine, pentamethylenediamine, hexamethylenediamine, octamethylenediamine, and xylylenediamine. Preferred homo- and copolyamides are polyamide 6, polyamide 12, polyamide 66, polyamide 610, polyamide 612, polyamide MXD6, polyamide 6/66, polyamide 6/12, polyamide 6I/6T.

The ethylene-vinyl alcohol copolymers are produced by saponification of copolymers of ethylene and vinyl acetate. In general, the amount of ethylene in the ethylene-vinyl alcohol copolymers is between 27 and 48 mole-%. Ethylene-vinyl alcohol copolymers are preferred for the gas barrier layer, and their ethylene proportion is between 34 and 48 mole-%.

The wall thickness of the gas barrier layers is 2 to 12 μm in the case of polyvinylidene chloride copolymers or 7 to 30 μm in the case of ethylene-vinyl alcohol copolymers or mixtures of polyamide with ethylene-vinyl alcohol.

For protection against mechanical damage from the outside, the gas barrier layer or layers can be followed by one or more layers of polyolefin and/or modified polyolefins.

The polyolefins are homopolymers of ethylene or propylene and/or copolymers of linear α-olefins having 2 to 8 C atoms. Modified polyolefins are copolymers of ethylene or propylene and optionally further linear α-olefins having 3 to 8 C atoms with α,β-unsaturated carboxylic acids, preferably acrylic acid, methacrylic acid and/or metal salts thereof and/or alkyl esters thereof, or appropriate graft copolymers of the above-mentioned monomers on polyolefins or partially saponified ethylene-vinyl acetate copolymers which are optionally graft-polymerized with an α,β-unsaturated carboxylic acid and have a low saponification level, or mixtures thereof. Furthermore, the modified polyolefins can be modified homo- or copolymers of ethylene and/or propylene and optionally other linear α-olefins having 3 to 8 C atoms, which have monomers from the group of α,β-unsaturated dicarboxylic acids, preferably maleic acid, fumaric acid, itaconic acid, or anhydrides, esters, amides or imides thereof grafted thereon.

The wall thickness of the outer protective layer or layers is between 4 and 25 μm.

The following structures will be mentioned as examples of possible layer structures, wherein the characters and numbers have the following meanings:
A: Mixture of polyolefin and modified polyolefin
B: Modified polyolefin
C: Polyolefin
D: Polyamide
E: Ethylene-vinyl alcohol
F: Mixture of polyamide and ethylene-vinyl alcohol
G: polyvinylidene chloride copolymer

The numerical indices 1,2, . . . denote multiple layers from the same class of raw materials.

Five-Layered Structure:

AB₁CB₂D; AB₁CB₂E; AB₁CB₂F; B₁B₂CB₃G; C₁B₁C₂B₂D
   Six-Layered Structure:
AB₁CB₂ED; B₁B₂CB₃EB₄; C₁C₂C₃BFA; B₁C₁C₂B₂GA
   Seven-Layered Structure:
C₁B₁C₂B₁D₁ED₂; AB₁CB₂D₁D₂D₁; B₁C₁C₂B₂D₁GD₂; C₁A₁C₂A₂EBC₃; B₁B₂CB₃EDB4; C₁A₁C₂A₂GBC₃
   Eight-Layered Structure:
AB₁CB₂D₁ED₂B₃; C₁B₁C₂B₁D₁D₂D₁A; B₁A₁C₁A₂DEB₂C₂
   Nine-Layered Structure:
C₁B₁C₂B₂D₁ED₂B₃C₃; AB₁C₁B₁D₁D₂D₁B₂C₂

In addition, conventional auxiliary agents such as anti-blocking agents, stabilizers, anti-static agents or lubricants can be included in the tubular films. Such auxiliary agents are normally added in amounts of from 0.01 to 5 wt.-%. Furthermore, the film can be colored by adding pigments or pigment mixtures.

The tubular films according to the invention are produced by coextrusion wherein the material of each layer is plastified and homogenized in one single extruder, so that at least five extruders in total are required in case of different layers. The primary tube is formed by a multilayer extrusion head supplied separately with the streams of melt, namely, in accordance with the desired layer thickness ratio. The primary tube is subsequently subjected to biaxial stretching and optional heat-setting. Heat-setting is a treatment following stretching, thereby stabilizing the molecular orientation achieved during stretching.

The tubular films of the invention have an overall wall thickness of from 30 to 120 μm, preferably from 40 to 100 μm.

The invention will be illustrated by way of examples:

The mechanical and technological properties of the tubular films according to the invention were determined with respect to seal seam strength and damaging energy, using a penetration test. The relative damaging energy is the quotient of damaging energy and wall thickness.

To determine the seal seam strength, each tubular film was welded inside at a right angle to the machine direction, using an SGPE 20 laboratory welding apparatus from W. Kopp Verpackungsmaschinen. The temperature of the sealing bar was 100 to 140° C. and the time of sealing 1 s. Strips 25 mm in width were taken from the welded tubular films in such a way that the weld seam was at a right angle to the length of the strip. The strip samples were stretched on a tensile testing machine from Instron Company at a stretching rate of 500 mm/min until breaking of the weld seam occurred. The resulting maximum force will be referred to as seal seam strength.

To determine the influence of soiling on the inside of the tubular film on the seal seam strength, fresh beef was cut into slices, placed in the tubular film, and pressed manually on the two opposite inner surfaces of the tubular film for a few seconds. A new slice of beef cut immediately prior to placing in the tubular film was used in each test. The piece of meat was subsequently removed, and heat-sealing was performed.

The damaging energy was determined following DIN 53 373, but deviating from that, a hardened cylindrical form A pin 3 mm in diameter, according to DIN EN 28 734, was used as impact body and the testing rate was 500 mm/min.

### EXAMPLE 1

A nine-layered tubular film according to the invention was produced by plastifying and homogenizing the individual polymers of the different layers in nine extruders. According to the desired single wall thickness ratios, the nine melt streams were fed into a nine-layer extrusion head and formed into a primary tube. The primary tube had a diameter of 73 mm and a mean overall wall thickness of 0.75 mm. This primary tube was subsequently subjected to biaxial stretching and heat-setting. For stretching, the primary tube was heated to 119° C. using infrared radiation and stretched at a surface stretch ratio of 9.6. The biaxially stretched tube was heat-set, flattened, and wound up. The mean overall wall thickness of the tube was 85 μm, and the flat width was 380 mm.

The layers of the nine-layered film tube thus produced had the following polymers with single wall thicknesses as indicated:

| | |
|---|---|
| Layer 1 | Polyethylene (mLLDPE), Luflexen 18PFFX from Basell |
| (inner layer) | Company, 10 μm |
| Layer 2 | Modified polyethylene, Surlyn 1652 from DuPont de |
| | Nemours GmbH, 5 μm |
| Layer 3 | Polyethylene (LLDPE), Dowlex 2049E from DOW |
| | Chemical Company, 15 μm |
| Layer 4 | Modified polyethylene, Admer NF 487 E from Mitsui |
| | Chemicals Inc., 5 μm |
| Layer 5 | Polyamide 6/66, Ultramid C 35 from BASF AG, 13 μm |
| Layer 6 | Ethylene-vinyl alcohol copolymer, Soarnol AT 4406 from |
| | Nippon Gohsei, 4 μm |
| Layer 7 | Polyamide 6/66, Ultramid C 35 from BASF AG, 13 μm |
| Layer 8 | Modified polyethylene, Admer NF 478 E from Mitsui |
| | Chemicals Inc., 5 μm |
| Layer 9 | Modified polyethylene (EVA), Escorene FL 00218 from |
| (outer layer) | Exxon Mobile Chemical, 15 μm |

Luflexen 18PFFX has the following properties:
Density 0.921 g/cm³
Melt index 1.0 g/10 min
Melting point 118° C.

The determined seal seam strengths were as follows:

| | Seal seam strength | Seal seam strength |
|---|---|---|
| Sealing temperature | No soiling | With soiling |
| (° C.) | (N/25 mm) | (N/25 mm) |
| 140 | 106 | 56 |
| 120 | 94 | 47 |
| 100 | 88 | 14 |

The damaging energy was 890 mJ, and the relative damaging energy was 10.5 J/mm.

### EXAMPLE 2

A five-layered film tube was produced by plastifying and homogenizing the individual polymers for the different layers in five extruders. According to the desired single wall thickness ratios, the five melt streams were fed into a five-layer extrusion head, formed into primary tube, and subjected to biaxial stretching and heat-setting. The primary tube initially produced had a diameter of 66 mm and a mean overall wall thickness of 0.63 mm. It was heated to 113° C. using infrared radiation and stretched at a surface stretch ratio of 9.6. The biaxially stretched tube was heat-set, flattened, and wound up. The mean overall wall thickness of the tube was 70 μm, and the flat width was 352 mm.

The layers of the final tube consist of the following polymers with single wall thicknesses as indicated:

| | |
|---|---|
| Layer 1 | Modified polyethylene, Surlyn 1705 from DuPont |
| (inner layer) | de Nemours GmbH, 11 μm |
| Layer 2 | Modified polyethylene (EAA), Primarcor 1320 from Dow |
| | Chemical, 7 μm |
| Layer 3 | Polyethylene (LDPE), Lupolen 1804 H from Basell |
| | Company, 15 μm |
| Layer 4 | Modified polyethylene, Surlyn 1652 from DuPont |
| | de Nemours GmbH, 7 μm |
| Layer 5 | Polyamide 6, Durethan B40F from Bayer AG, 30 μm |
| (outer layer) | |

Surlyn 1705 has the following properties:
Density 0.95 g/m³
Melt index 5.5 g/10 min
Melting point 87° C.

The following seal seam strengths were determined:

| | Seal seam strength | Seal seam strength |
|---|---|---|
| Sealing temperature | No soiling | With soiling |
| (° C.) | (N/25 mm) | (N/25 mm) |
| 140 | 56 | 27 |
| 120 | 56 | 20 |
| 100 | 46 | 11 |

The damaging energy was 720 mJ, and the relative damaging energy was 10.3 J/mm.

### COMPARATIVE EXAMPLE 1

A five-layered tubular film was produced as in Example 2, in which case the outer layer, core layer and intermediate layers were identical, but the inner layer contained a large amount of polyamide.

The layers of the final tube have the following polymers, with single wall thicknesses as indicated:

| | |
|---|---|
| Layer 1 | Blend of 90% polyamide 6/12, Grilon CF6S from EMS- |
| (inner layer) | Chemie with 10% ionomer resin, Surlyn 1652 from DuPont |
| | de Nemours GmbH, 11 μm |
| Layer 2 | Modified polyethylene (EAA), Primarcor 1320 from Dow |
| | Chemical, 7 μm |
| Layer 3 | Polyethylene (LDPE), Lupolen 1804 H from Basell |
| | Company, 15 μm |
| Layer 4 | Modified polyethylene, Surlyn 1652 from DuPont |
| | de Nemours GmbH, 7 μm |
| Layer 5 | Polyamide 6, Durethan B40F from Bayer AG, 30 μm |
| (outer layer) | |

The determined seal seam strengths were:

| | Seal seam strength | Seal seam strength |
|---|---|---|
| Sealing temperature | No soiling | With soiling |
| (° C.) | (N/25 mm) | (N/25 mm) |
| 140 | 100 | 3 |
| 120 | 92 | 2 |
| 100 | 0 | 0 |

The damaging energy was 630 mJ, and the relative damaging energy was 9.0 J/mm.

### COMPARATIVE EXAMPLE 2

Commercially available Boneguard bags, Cryovac TBG from Sealed Air Corporation, are an example of bags for packing meat with bones according to the prior art. For reinforcement, these bags are provided with a reinforcing film on both outer surfaces, which has a wall thickness of 130 μm and is applied by means of adhesion. The bag material itself has a thickness of only 60 μm, resulting in an overall thickness of 190 μm in that area which has the reinforcement film adhered thereon. The penetration test to determine the damaging energy was effected in this area.

The seal seam was placed in the area having no additional reinforcing film on the bag, and the following values were determined:

| | Seal seam strength | Seal seam strength |
|---|---|---|
| Sealing temperature | No soiling | With soiling |
| (° C.) | (N/25 mm) | (N/25 mm) |
| 140 | 36 | 16 |
| 120 | 35 | 9 |
| 100 | 20 | 0 |

The damaging energy was 710 mJ, and the relative damaging energy was 3.7 J/mm.

Even at a sealing temperature of only 100° C., the inventive tubular films according to Example 1 and Example 2 afford high seal seam strengths of 88 and 46 N/25 mm, respectively, in the absence of soiling, while the film of Comparative Example 1 could not be sealed at this temperature, and the film according to Comparative Example 2 achieved a seal seam strength of only 20 N/25 mm. When sealing at 100° C. through a soiled area, seal seam strengths of 14 and 11 N/25 mm, respectively, which is acceptable for practical use, can only be achieved by the tubular films according to the invention, while the tubular films of both comparative examples could no longer be welded at this temperature.

In conclusion, the examples demonstrate that a combination of good puncture resistance and good sealability or weldability, in the presence or absence of soiling, exists only in the tubular films according to the invention, which can also be seen in a relative damaging energy of more than 10 J/mm and a high seal seam strength at sealing temperatures of only 100 and 120° C.

1. A tubular film comprising at least five layers wherein each of the first four layers, counted from the inside to the outside, consists of at least one polyolefin and/or modified polyolefin, and that these layers are followed by one layer or more layers based on polyvinylidene chloride copolymer and/or polyamide and/or ethylene-vinyl alcohol copolymer and/or polyolefin and/or modified polyolefin.

2. The tubular film according to claim 1, wherein the first layer consists of homopolymers of ethylene or propylene and/or copolymers of linear α-olefins having 2 to 8 C atoms.

3. The tubular film according to claim 2, wherein the polyolefins of the first layer consist of linear low-density polyethylene, high-density polyethylene, polypropylene homopolymers, polypropylene block copolymers and polypropylene random copolymers.

4. The tubular film according to claim 3, wherein the first layer consists of at least one polyethylene produced using a metallocene catalyst.

5. The tubular film according to claim 1, wherein the first layer includes modified polyolefins, said modified polyolefins being copolymers of ethylene or propylene and optionally further linear α-olefins having 3 to 8 C atoms with α,β-unsaturated carboxylic acids, preferably acrylic acid, methacrylic acid and/or metal salts thereof and/or alkyl esters thereof, and/or graft copolymers of α,β-unsaturated dicarboxylic acids, preferably maleic acid, fumaric acid, itaconic acid, and anhydrides, esters, amides or imides thereof on polyolefins or polyolefin copolymers.

6. The tubular film according to claim 1, wherein the first layer consists of a polyolefin and/or modified polyolefin with a melting point of 70-130° C., a density of 0.86-0.98 g/cm³ and a melt index of 0.2-15 g/10 min.

7. The tubular film according to claim 1, wherein the third layer consists of homopolymers of ethylene or propylene and/or copolymers of linear α-olefins having 2 to 8 C atoms.

8. The tubular film according to claim 7, wherein the polyolefins of the third layer preferably consist of linear low-density polyethylene, high-density polyethylene, polypropylene homopolymers, polypropylene block copolymers and polypropylene random copolymers.

9. The tubular film according to claim 1, wherein the second layer and the fourth layer consist of polyolefins and/or modified polyolefins.

10. The tubular film according to claim 9, wherein the polyolefins are homopolymers of ethylene or propylene and/or copolymers of linear α-olefins having 2 to 8 C atoms.

11. The tubular film according to claim 9, wherein the modified polyolefins are copolymers of ethylene or propylene and optionally further linear α-olefins having 3 to 8 C atoms with α,β-unsaturated carboxylic acids, preferably acrylic acid, methacrylic acid and/or metal salts thereof and/or alkyl esters thereof, and/or graft copolymers of α,β-unsaturated dicarboxylic acids, preferably maleic acid, fumaric acid, itaconic acid, or anhydrides, esters, amides or imides thereof on polyolefins or polyolefin copolymers.

12. The tubular film according to claim 1, wherein the layer or one of the layers following the first four layers consists of polyvinylidene copolymer constituted of vinylidene chloride and vinyl chloride and/or methacrylate monomers, the proportion of vinylidene chloride being at least 50%.

13. The tubular film according to claim 1, wherein the layer or one of the layers following the first four layers consists of a homopolyamide and/or copolyamide or mixtures of such polyamides which are produced from monomers selected from the group consisting of caprolactam, laurinlactam, ω-aminoundecanoic acid, adipic acid, azelaic acid, sebacic acid, decanedicarboxylic acid, dodecanedicarboxylic acid, terephthalic acid, isophthalic acid, tetrainethylenediamine, pentamethylenediamine, hexamethylenediamine, octamethylenediamine, xylylenediamine and mixtures thereof.

14. The tubular film according to claim 1, wherein the layer or one of the layers following the first four layers consists of ethylene-vinyl alcohol copolymer, characterized in that the proportion of ethylene is between 27 and 48 mole-%, preferably between 34 and 48 mole-%.

15. The tubular film according to claim 1, wherein the layer or one of the layers following the first four layers consists of blends of ethylene-vinyl alcohol copolymer and polyamide.

16. The tubular film according to claim 1, wherein the layer or one of the layers following the first four layers consists of a polyolefin and/or a modified polyolefin or blends of the above polymers with each other.

17. The tubular film according to claim 16, wherein the polyolefins are homopolymers of ethylene or propylene and/or copolymers of linear α-olefins having 2 to 8 C atoms.

18. The tubular film according to claim 16, wherein the modified polyolefins are copolymers of ethylene or propylene and optionally further linear α-olefins having 3 to 8 C atoms with α,β-unsaturated carboxylic acids, preferably acrylic acid, methacrylic acid and/or metal salts thereof and/or alkyl esters thereof, and/or graft copolymers of α,β-unsaturated dicarboxylic acids, preferably maleic acid, fumaric acid, itaconic acid, and anhydrides, esters, amides or imides thereof on polyolefins or polyolefin copolymers.

19. The tubular film according to claim 1, wherein the tubular film has been subjected to coextrusion and biaxial stretching.

20. The tubular film according to claim 1, wherein the tubular film has been subjected to coextrusion, biaxial stretching and subsequent heat-setting.

21. The tubular film according to claim 1, wherein the tubular film has a wall thickness of from 30 to 120 μm, preferably from 40 to 100 μm.

22. A method for packaging and wrapping meat, meat with bones, or pasty foodstuffs comprising packaging and wrapping meat, meat with bones, or pasty foodstuffs with the tubular film as claimed in claim 1.

23. A bag wherein said bag is produced from a tubular film according to claim 1 by welding or sealing the inner layer on itself.

24. A method for packaging and wrapping meat, meat with bones, or pasty foodstuffs comprising packaging and wrapping meat, meat with bones, or pasty foodstuffs with the bag as claimed in claim 23.

25. A tubular film as claimed in claim 1 wherein said tubular film is biaxially oriented, shrinkable and sealable.

26. A food wrap comprising the tubular film as claimed in claim 1.

27. A food package comprising the tubular film as claimed in claim 1.
